(19) United States
(12) Patent Application Publication
(10) Pub. No.: US 2019/0102153 A1
(43) Pub. Date: Apr. 4, 2019

(54) INFORMATION PROCESSING APPARATUS, INFORMATION PROCESSING METHOD, AND RECORDING MEDIUM RECORDING PROGRAM

(71) Applicant: FUJITSU LIMITED, Kawasaki-shi (JP)

(72) Inventor: Yoshinori Tomita, Yokohama (JP)

(73) Assignee: FUJITSU LIMITED, Kawasaki-shi (JP)

(21) Appl. No.: 16/140,686

(22) Filed: Sep. 25, 2018

(30) Foreign Application Priority Data
Oct. 3, 2017 (JP) 2017-193294

(51) Int. Cl. G06F 8/41; G06F 12/06; G06F 12/02

(52) U.S. Cl. CPC G06F 8/4442; G06F 12/023; G06F 12/06

(57) ABSTRACT

An information processing apparatus includes a memory, and a processor coupled to the memory, wherein the processor is configured to acquire, by analyzing a program, a first address of the memory at which a memory access instruction in the program is stored, and a second address of the memory to be accessed by the memory access instruction, and generate first information indicating a correspondence between the first address and the second address.

### CROSS-REFERENCE TO RELATED APPLICATION

This application is based upon and claims the benefit of priority of the prior Japanese Patent Application No. 2017-193294, filed on Oct. 3, 2017, the entire contents of which are incorporated herein by reference.

### FIELD

The embodiments discussed herein are related to an information processing apparatus, an information processing method, and a recording medium in which a program is recorded.

### BACKGROUND

In a target code pre-transformation method, target code is transformed into host code before execution.

The related art is disclosed in Japanese Laid-open Patent Publication Nos. 2012-159936 and 7-84799.

### SUMMARY

According to an aspect of the embodiments, an information processing apparatus includes: a memory; and a processor coupled to the memory, the processor is configured to: acquire, by analyzing a program, a first address of the memory at which a memory access instruction in the program is stored, and a second address of the memory to be accessed by the memory access instruction; and generate first information indicating a correspondence between the first address and the second address.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a hardware configuration example of an information processing apparatus;

FIG. 2 illustrates a processing example of a compiler, a dynamic analysis tool, and a memory access data analysis tool;

FIG. 3 illustrates an example of a source file;

FIG. 4 illustrates an example of memory access data;

FIG. 5A illustrates an example of a graph structure generated by a graph generation module;

FIG. 5B illustrates an example of a graph structure generated by a grouping module;

FIG. 6A illustrates an example of grouping of instruction address nodes;

FIG. 6B illustrates an example of grouping of memory address nodes;

FIG. 7 illustrates an example of a graph structure generated by the grouping module and a labeling module;

FIG. 8A illustrates an example of an accelerator including a shared memory;

FIG. 8B illustrates an example of an accelerator including two shared memories;

FIG. 9 illustrates an example of processing of a dynamic analysis tool;

FIG. 10A illustrates an example of processing in the case where the processing reaches a first breakpoint;

FIG. 10B illustrates an example of processing in the case where the processing reaches a second breakpoint;

FIG. 11 illustrates an example of processing in the case where a memory access monitor area is accessed; and

FIG. 12 illustrates an example of processing of a memory access data analysis tool.

### DESCRIPTION OF EMBODIMENTS

Target code is decomposed into, for example, basic blocks, each of which is a minimum unit of a sequence of instructions in which a branch instruction or an entry from a branch instruction does not take place. The instructions in the target code are parsed for each basic block, so that read instructions from registers, write instructions to the registers, read instructions from a memory, write instructions to the memory, and arithmetic and logical instructions are detected. In this case, a dependency graph is generated in which a dependency relationship of a value to be loaded to a certain register on a value in another register or a memory content is represented together with nodes and edges concerning instructions. A memory reference table is used every time a read or write access to the memory takes place. In the memory reference table, a content read from the memory and a content written to the memory are respectively associated with address values. By linking the dependency graph and the memory reference table with each other, all possible address values as jump destination addresses of branch instructions are listed as entry points in the course of pre-transformation of the branch instructions.

For example, by compiling, an object program with high performance is generated for a computer having a cache memory. The occurrence of cache contention between memory references in an input program is detected.

A processor is able to perform processing by running software. In order to make processing faster than the processing by software, the processing may be performed by hardware, namely, a field-programmable gate array (FPGA). To develop the FPGA, a hardware designer has to first understand the processing contents by the software and then to create hardware operation description aiming at hardware architecture, which may be difficult to accomplish.

For example, it may be desirable to provide a technique of assisting creation of hardware operation description aiming at hardware architecture.

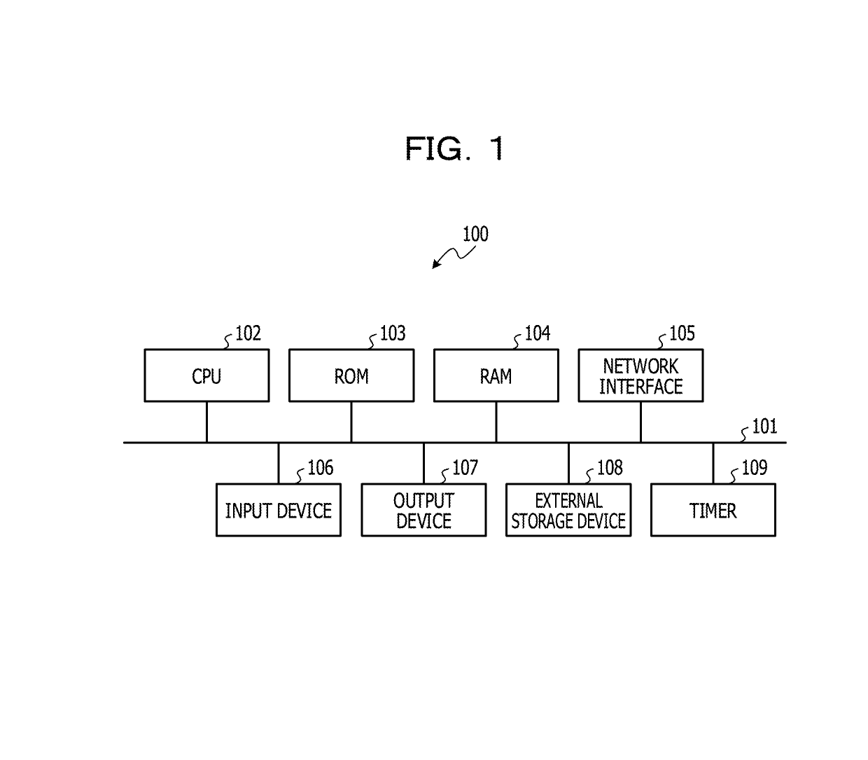

FIG. 1 is a diagram illustrating a hardware configuration example of an information processing apparatus 100 according to an embodiment. The information processing apparatus 100 is a computer, and includes a bus 101, a central processing unit (CPU) 102, a read-only memory (ROM) 103, a random access memory (RAM) 104, a network interface 105, an input device 106, an output device 107, an external storage device 108, and a timer 109.

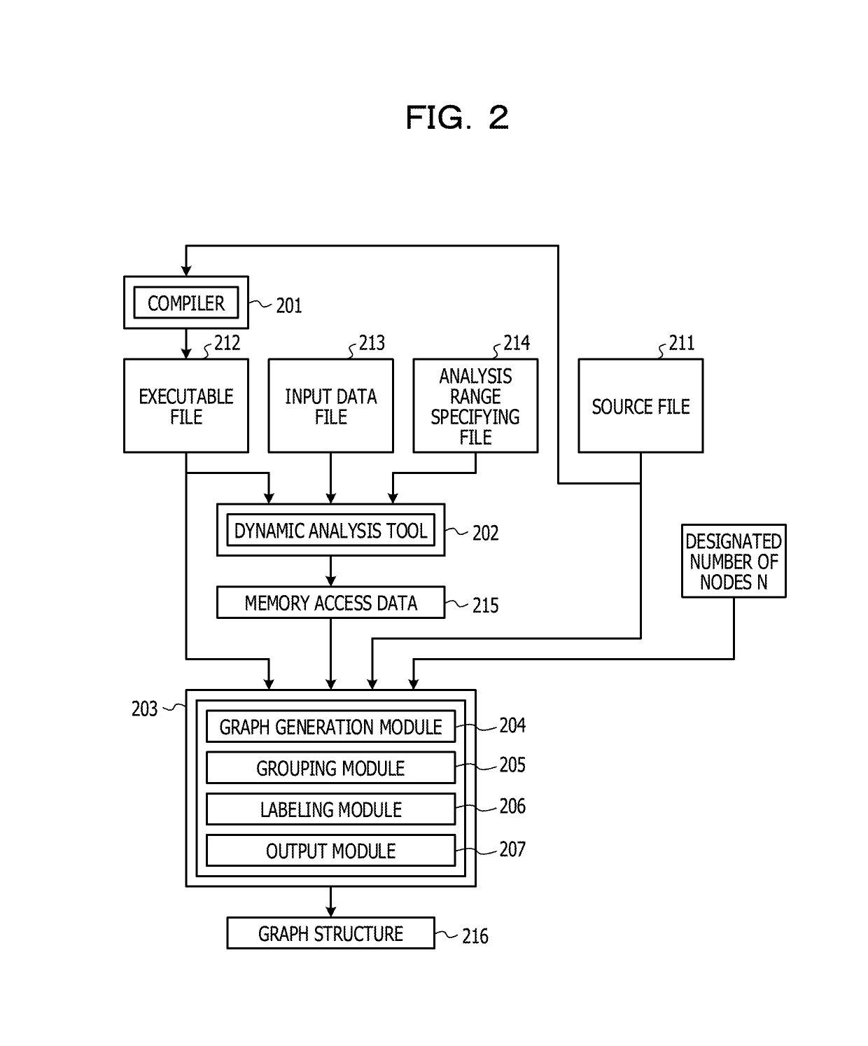

The CPU 102 performs data processing or computations, and controls the constituent elements coupled to the CPU 102 via the bus 101. The ROM 103 stores a startup program. The CPU 102 starts operating by executing the startup program in the ROM 103. The external storage device 108 stores a program containing a compiler 201, a dynamic analysis tool 202, and a memory access data analysis tool 203 illustrated in FIG. 2. The CPU 102 loads, onto the RAM 104, and executes the program stored in the external storage device 108 and containing the compiler 201, the dynamic analysis tool 202, and the memory access data analysis tool 203. The RAM 104 stores the program and data. The external storage device 108 is, for example, a hardware storage device, a CD-ROM, or the like, which does not lose the stored contents even if being powered off. The network interface 105 is an interface to connect to a network such as the Internet. The input device 106 is, for example, any of a keyboard, a mouse, and so on, and is capable of accepting various kinds of designations and inputs. The output device 107 is any of a display, a printer and so on. The timer 109 generates time information.

The present embodiment may be implemented with the computer running a program. In addition, a computer-readable recording medium in which the aforementioned program is recorded and a computer program product of the aforementioned program or the like may be applied as embodiments of the present disclosure. Examples usable as the recording medium include a flexible disk, a hard disk, an optical disk, a magneto-optical disk, a CD-ROM, a magnetic tape, a non-volatile memory card, a ROM, and so on.

Next, an accelerator is explained. The processor is capable of performing various kinds of processes by executing the program. The processing of the program is performed at relatively low speed. In the case where a large volume of data is processed at high speed, the processing of the program executed by the processor is disadvantageous in the aspects of processing speed and power consumption. In this case, an accelerator may be used such as a general-purpose computing on graphics processing units (GPGPU) or FPGA. The accelerator is hardware and is advantageous in the aspects of processing speed and power consumption. The designer classifies desired processing into processing to be executed by the accelerator and processing to be executed by the processor according to their processing contents and processing purposes. Then, the designer writes the processing for the accelerator as source code in a description language for hardware designing (for example, the C language if a high-level synthesis tool is used). Lastly, the designer accomplishes development of the accelerator based on the source code by using the high-level synthesis tool and so on.

In the case where a FPGA is employed to implement the accelerator, the development of the hardware circuit involves a large number of man-hours. Use of the high-level synthesis tool allows designing with high-level language description at a high level of abstraction and therefore may reduce the number of man-hours for the development of the hardware circuit. Even in this case, however, in order to generate an excellent circuit, the designer has to create the source code in the high-level language description for the high-level synthesis by aiming at the hardware architecture.

If usual high-level language description is directly given to the high-level synthesis tool, the high-level synthesis tool often causes a problem of generating a circuit with low performance or a circuit too enormous to be layouted on a FPGA. To avoid this, the hardware designer desirably first understands the processing contents of the source code desired to be implemented as the accelerator, and then newly writes high-level language description aiming at hardware architecture. It takes a certain number of man-hours for the designer to understand the processing contents of the source code to be processed by the processor. The creation of the source code in the high-level language description suited to the accelerator relies on the degree of understanding of the source code to be processed by the processor and the skill level of the designer. In view of this, the present embodiment is intended to provide the information processing apparatus 100 capable of assisting creation of source code aiming at hardware architecture.

FIG. 2 is a diagram for explaining a processing example of the compiler 201, the dynamic analysis tool 202, and the memory access data analysis tool 203 executed by the information processing apparatus 100. The compiler 201, the dynamic analysis tool 202, and the memory access data analysis tool 203 are computer programs and executed by the CPU 102 in the information processing apparatus 100. A source file 211, an input data file 213, and a analysis range specifying file 214 are stored in the external storage device 108 in FIG. 1. The source file 211 may be a single file or be composed of two or more divided files. The source file 211 is source code in high-level language description corresponding to a program originally executed by the processor. The processing desired to be implemented as the accelerator is contained as part of the source file 211. Hereinafter, an information processing method of the information processing apparatus 100 is described.

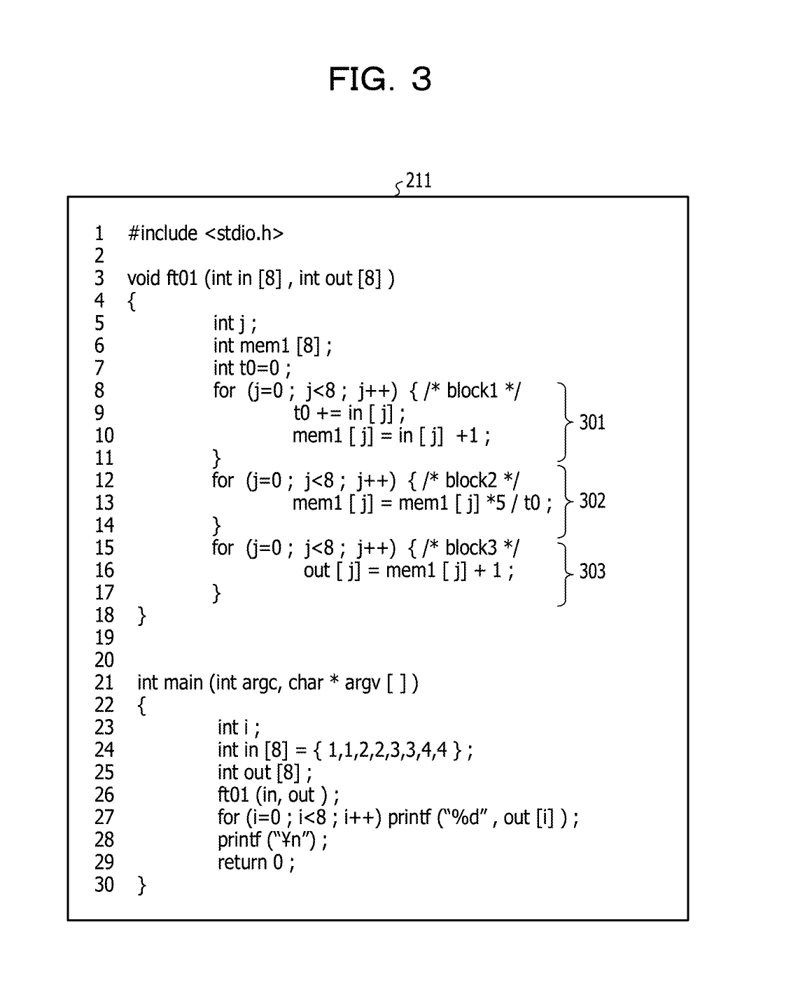

FIG. 3 is a diagram illustrating an example of the source file 211. The source file 211 is source code described in the C language. The numbers on the left end of the source file 211 indicate line numbers in the source file 211. The source file 211 contains a function main on the line 21, and a function ft01 on the line 3. The function main contains variables i, in, and out. The variables in and out are array variables. The function ft01 contains variables j, mem1, and t0. The variable mem1 is an array variable. Here, consecutive lines in the source file are called a code block. The code blocks are smaller units into which the function is divided. The function ft01 includes a first code block 301 of a for sentence on the lines 8 to 11, a second code block 302 of a for sentence on the lines 12 to 14, and a third code block 303 of a for sentence on the lines 15 to 17. In each of the above three for sentences, a loop process is iterated 8 times. The code blocks 301, 302, and 303 are each formed in such way that a range constituting a loop process is set as one code block. Although not explicitly indicated in FIG. 3, consecutive lines not included in the code blocks for the loop processes also constitute code blocks. In FIG. 3, the lines 4 to 7 constitute a code block, the lines 22 to 26 constitute a code block, and the lines 28 to 30 constitute a code block.

In FIG. 2, the designer gives a command to compile the source file 211 with order of generating debug information. For example, in the case of using a GCC compiler, the designer may order the generation of the debug information by specifying the -g option. Running the compiler 201, the CPU 102 compiles the source file 211 to generate an executable file 212 containing the debug information. Then, the CPU 102 writes the executable file 212 to the external storage device 108. The executable file 212 is a program in a machine language, and is a file executable by the CPU 102. There are standardized file formats for debug information, and the above debug information is, for example, in the DWARF format. For example, the source code on the line 10 in the source file 211 in FIG. 3 is transformed into an instruction in the executable file 212 by the compiler 201, the instruction containing a read instruction (load instruction) and a write instruction (store instruction) from and to the RAM (memory) 104. The read instruction and the write instruction are memory access instructions to the RAM 104. The debug information contains information according to which the address of the RAM 104 where a memory access instruction is stored may be linked with a location (the file name and the line number) in the source code in the source file 211. The executable file 212 contains the debug information indicating correspondences between the executable file 212 and the source file 211 before the compiling of the executable file 212. Using the address in the RAM 104 where a memory access instruction in the executable file 212 is stored, the memory access data analysis tool 203 may acquire the location in the source code within the source file 211 (the file name and the line number in the source file 211) corresponded to the memory access instruction by using the debug information. In addition, the memory access data analysis tool 203 is capable of corresponding the address of a data area statically arranged (a variable declared with a static modifier in the C language) to a variable name in the source file 211

Running the dynamic analysis tool 202, the CPU 102 inputs the executable file 212, the input data file 213, and the analysis range specifying file 214 and generates memory access data 215. The input data file 213 is a file containing input data for the executable file 212 and may be omitted. For example, input data is described on the line 24 in the source file 211 in FIG. 3. The analysis range specifying file 214 is a file specifying a variable in the source file 211 targeted by memory access analysis. The analysis range specifying file 214 contains one or more sets each of [the file name of the source file 211, the line number, and the variable name]. For example, they are specified as in [“ft01.c”, 24, in].

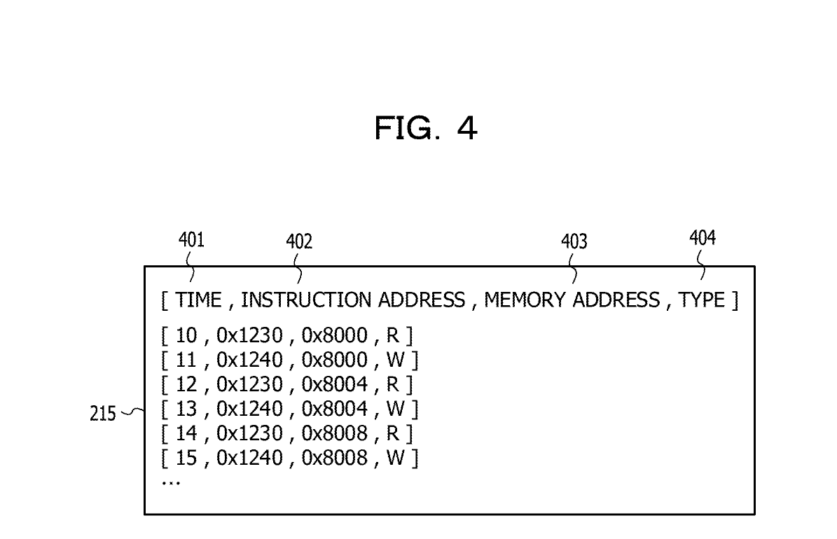

FIG. 4 is a diagram illustrating an example of the memory access data 215. The memory access data 215 contains multiple sets of a time 401, an instruction address 402, a memory address 403, and a type 404. The instruction address 402 is the address in the RAM 104 where a memory access instruction in the executable file 212 is stored. The memory address 403 is the address in the RAM 104 to be accessed by a memory access instruction in the executable file 212. The type 404 is information indicating whether a memory access instruction in the executable file 212 is a read instruction R or a write instruction W from and to the RAM 104. The time 401 is information on a time at which a memory access instruction in the executable file 212 was executed, and does not have to be an actual time but may indicate the sequential number of the memory access instruction in the execution order.

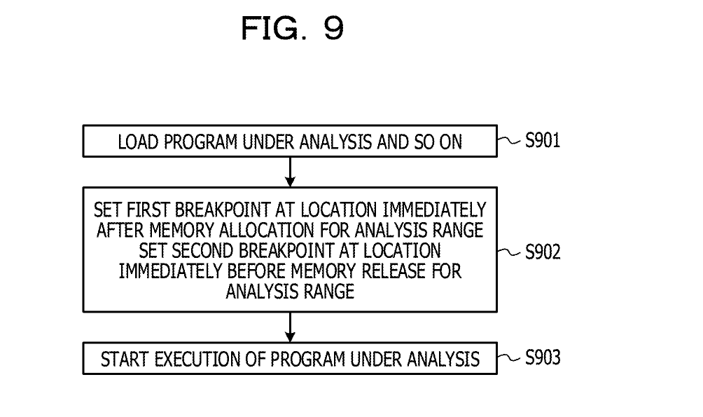

Running the dynamic analysis tool 202, the CPU 102 parses the executable file 212 and generates the memory access data 215 by acquiring the time 401, the instruction address 402, the memory address 403, and the type 404 correspondent with an access of each variable name in the source file 211 specified in the analysis range specifying file 214. The memory access data 215 contains information indicating each association among the time 401, the instruction address 402, the memory address 403, and the type 404. Note that the time 401 and the type 404 may be omitted. The detailed processing of the dynamic analysis tool 202 will be described later with reference to FIGS. 9 to 11.

In FIG. 2, the memory access data analysis tool 203 includes modules named a graph generation module 204, a grouping module 205, a labeling module 206, and an output module 207. Running the memory access data analysis tool 203, the CPU 102 inputs the source file 211, the executable file 212, the memory access data 215, and a designated number of nodes N, and outputs a graph structure 216. Hereinafter, processing of the graph generation module 204, the grouping module 205, the labeling module 206, and the output module 207 is explained.

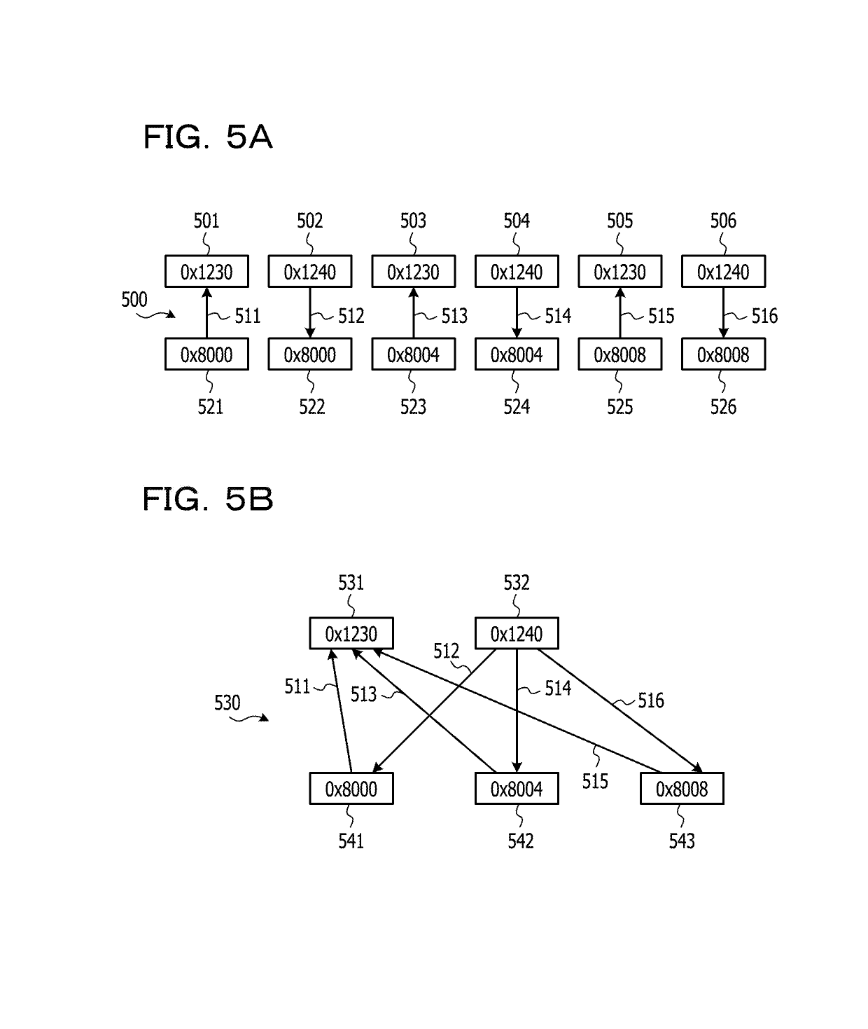

FIG. 5A is a diagram illustrating an example of an initial state of a graph structure 500 generated by the graph generation module 204 in FIG. 2. Running the graph generation module 204, the CPU 102 generates the graph structure 500 in FIG. 5A based on the memory access data 215 in FIG. 4. The graph structure 500 includes multiple instruction address nodes 501 to 506, multiple memory address nodes 521 to 526, and multiple edges 511 to 516. The six instruction address nodes 501 to 506 are nodes respectively representing the six instruction addresses 402 in FIG. 4. The six memory address nodes 521 to 526 are nodes respectively representing the six memory addresses 403 in FIG. 4. The six edges 511 to 516 respectively indicate correspondence between the six instruction address nodes 501 to 506 and the six memory address nodes 521 to 526. In addition, the six edges 511 to 516 are directed edges and have directions respectively according to the six data pieces in the type 404 in FIG. 4. The edges 511, 513, and 515 are edges directed from the lower memory address nodes to the upper instruction address nodes, and indicate that their type 404 is the read instruction R. The edges 512, 514, and 516 are edges directed from the upper instruction address nodes to the lower memory address nodes, and indicate that their type 404 is the write instruction W.

FIG. 5B is a diagram illustrating an example of a graph structure 530 generated by the grouping module 205 in FIG. 2. Running the grouping module 205, the CPU 102 performs grouping (clustering) of the multiple instruction address nodes 501 to 506 in the graph structure 500 in FIG. 5A to reduce the number of the instruction address nodes and generate instruction address nodes 531 and 532 in FIG. 5B. Specifically, the CPU 102 groups together the instruction address nodes 501, 503, and 505 representing the same instruction address “0x1230” in FIG. 5A to generate one instruction address node 531 representing the instruction address “0x1230” in FIG. 5B. In addition, the CPU 102 groups together the instruction address nodes 502, 504, and 506 representing the same instruction address “0x1240” in FIG. 5A to generate one instruction address node 532 representing the instruction address “0x1240” in FIG. 5B.

Meanwhile, running the grouping module 205, the CPU 102 performs grouping of the multiple memory address nodes 521 to 526 in the graph structure 500 in FIG. 5A to reduce the number of the memory address nodes and generate memory address nodes 541 to 543 in FIG. 5B. Specifically, the CPU 102 groups together the memory address nodes 521 and 522 representing the same memory address “0x8000” in FIG. 5A to generate one memory address node 541 representing the memory address “0x8000” in FIG. 5B. In addition, the CPU 102 groups together the memory address nodes 523 and 524 representing the same memory address “0x8004” in FIG. 5A to generate one memory address node 542 representing the memory address “0x8004” in FIG. 5B. Moreover, the CPU 102 groups together the memory address nodes 525 and 526 representing the same memory address “0x8008” in FIG. 5A to generate one memory address node 543 representing the memory address “0x8008” in FIG. 5B.

The edge 511 is an edge directed from the memory address node 541 to the instruction address node 531 and represents the read instruction R. The edge 512 is an edge directed from the instruction address node 532 to the memory address node 541 and represents the write instruction W. The edge 513 is an edge directed from the memory address node 542 to the instruction address node 531 and represents the read instruction R. The edge 514 is an edge directed from the instruction address node 532 to the memory address node 542 and represents the write instruction W. The edge 515 is an edge directed from the memory address node 543 to the instruction address node 531 and represents the read instruction R. The edge 516 is an edge directed from the instruction address node 532 to the memory address node 543 and represents the write instruction W.

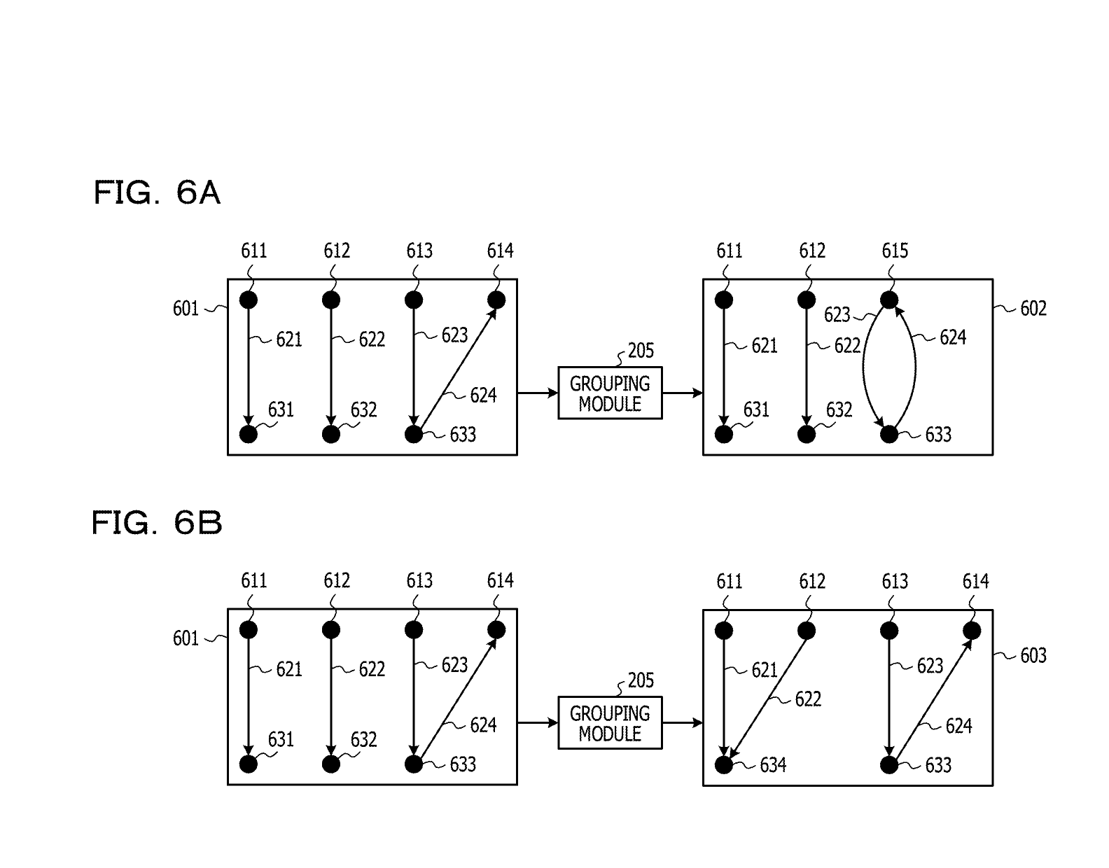

FIG. 6A is a diagram for explaining an example of grouping of instruction address nodes. Running the grouping module 205, the CPU 102 performs grouping in a graph structure 601 to generate a graph structure 602. The graph structure 601 contains instruction address nodes 611 to 614, edges 621 to 624, and memory address nodes 631 to 633. The edge 621 is an edge directed from the instruction address node 611 to the memory address node 631 and represents the write instruction W. The edge 622 is an edge directed from the instruction address node 612 to the memory address node 632 and represents the write instruction W. The edge 623 is an edge directed from the instruction address node 613 to the memory address node 633 and represents the write instruction W. The edge 624 is an edge directed from the memory address node 633 to the instruction address node 614 and represents the read instruction R.

The grouping module 205 groups together the two instruction address nodes 613 and 614 in the graph structure 601 to generate one instruction address node 615 in the graph structure 602. The graph structure 602 contains instruction address nodes 611, 612, and 615, edges 621 to 624, and memory address nodes 631 to 633. The edge 623 is an edge directed from the instruction address node 615 to the memory address node 633 and represents the write instruction W. The edge 624 is an edge directed from the memory address node 633 to the instruction address node 615 and represents the read instruction R.

FIG. 6B is a diagram for explaining an example of grouping of memory address nodes. Running the grouping module 205, the CPU 102 performs grouping in a graph structure 601 to generate a graph structure 603. The graph structure 601 in FIG. 6B is the same as the graph structure 601 in FIG. 6A. The CPU 102 groups together the two memory address nodes 631 and 632 in the graph structure 601 to generate one memory address node 634 in the graph structure 603. The graph structure 603 contains instruction address nodes 611 to 614, edges 621 to 624, memory address nodes 633 and 634. The edge 621 is an edge directed from the instruction address node 611 to the memory address node 634 and represents the write instruction W. The edge 622 is an edge directed from the instruction address node 612 to the memory address node 634 and represents the write instruction W.

Next, an example of 10 types of grouping processes is explained. First to Sixth grouping processes are processes of grouping instruction address nodes as illustrated in FIG. 6A. Seventh to tenth grouping processes are processes of grouping memory address nodes as illustrated in FIG. 6B. Here, the ten types of grouping processes are explained as an example, but the grouping method is not limited to these. The CPU 102 may obtain a simple graph structure containing a smaller number of nodes by replacing nodes having the same characteristics with one node. The simple graph structure provides graphic representation easily understandable by humans and facilitates understanding of the processing contents in the source file 211.

The first grouping process performs grouping by instruction address. The grouping module 205 groups multiple instruction address nodes 501, 503, and 505 representing the same instruction address into one instruction address node 531 as illustrated in FIGS. 5A and 5B.

The second grouping process performs grouping by source file. The grouping module 205 groups instruction address nodes representing multiple instruction addresses contained in the same source file among multiple source files 211 into one instruction address node.

The third grouping process performs grouping by function. The grouping module 205 groups instruction address nodes representing instruction addresses correspondent with source code lines contained in the same function main or ft01 in the source file 211 in FIG. 3 into one instruction address node.

The fourth grouping process performs grouping by code block. The grouping module 205 groups instruction address nodes representing instruction addresses correspondent with source code lines contained in the same code block among the code blocks 301 to 303 in the source file 211 in FIG. 3 into one instruction address node.

The fifth grouping process performs grouping by loop process iteration. In reference to the time 401 in the memory access data 215 in FIG. 4, the grouping module 205 groups instruction address nodes representing instruction addresses correspondent with source code lines contained in each loop process iteration of the loop process of the for sentence in the source file 211 in FIG. 3 into one instruction address node. This grouping process uses the time 401.

The sixth grouping process performs grouping by set of multiple functions including a certain function and a function to be called by the certain function. The grouping module 205 groups an instruction address node representing an instruction address correspondent with the source code contained in a first function (for example, main) and an instruction address node representing an instruction address correspondent with the source code contained in a second function (for example, ft01) to be called by the first function in the source file 211 in FIG. 3 into one instruction address node. A function and the number of chained calls targeted by the grouping may be set as appropriate.

The seventh grouping process performs grouping by memory address. The grouping module 205 groups multiple memory address nodes 521 and 522 representing the same memory address into one memory address node 541 as illustrated in FIGS. 5A and 5B.

The eighth grouping process performs grouping by variable. The grouping module 205 groups memory address nodes representing multiple memory addresses contained in a memory area correspondent with each variable in the source file 211 into one memory address node. For example, the array variable mem1 in FIG. 3 has a certain address range for storing eight data pieces of the int type. The memory area is defined as an address range from the start address to the end address allocated to the array variable mem1. For example, all the memory address nodes included in the address range allocated to the array variable mem1 [0] to mem1 [7] are grouped into one memory address node.

The ninth grouping process performs grouping by set of memory accesses made by instructions consecutively executed. In reference to the time 401 in the memory access data 215 in FIG. 4, the grouping module 205 groups memory address nodes representing memory addresses correspondent with memory accesses consecutive in the time 401 (memory addresses accessed by instructions executed consecutively in terms of time) into one memory address node.

In the tenth grouping process, memory areas dynamically allocated are taken into account. The grouping module 205 groups memory address nodes representing different memory addresses for the same variable name (for example, in, out, mem1, or the like) in the source file 211 in FIG. 3 into one memory address node. For example, in the case where the same function ft01 is called multiple times within the function main in the source file 211 in FIG. 3, there is a possibility that every time a variable such as the variable mem1 in the function ft01 the variable is called, the memory area at a different memory address is allocated to the variable. In this case, the CPU 102 groups memory address nodes representing the different memory addresses allocated to the same variable name mem1 into one memory address node.

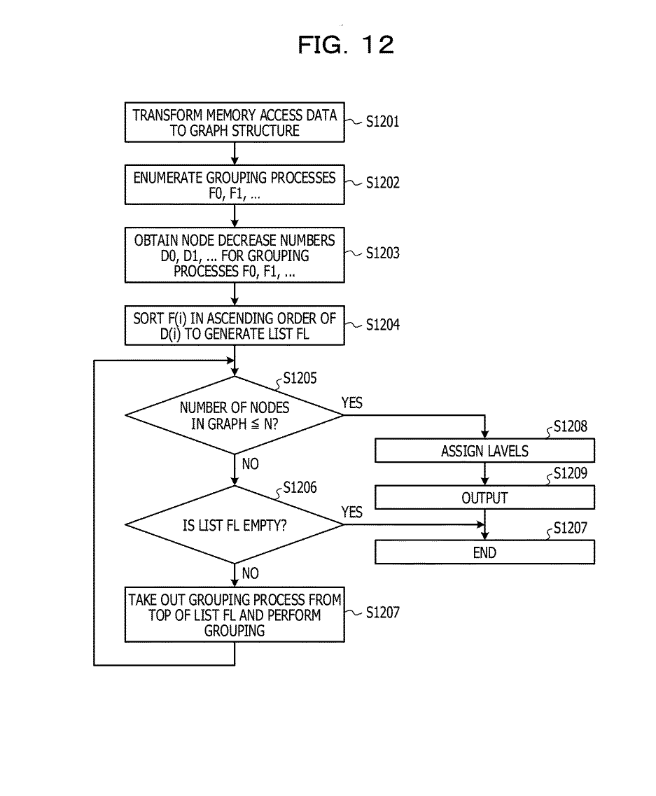

In FIG. 2, the designated number of nodes N is inputted by the designer using the input device 106 in FIG. 1, and indicates the upper limit number of nodes after the grouping. Running the grouping module 205, the CPU 102 performs the grouping of nodes based on the debug information in the executable file 212 by combining some of the aforementioned multiple types of grouping processes so that the total number of instruction address nodes and memory address nodes after the grouping becomes equal to or less than the designated number of nodes N. The detailed processing of the grouping module 205 is described later with reference to FIG. 12.

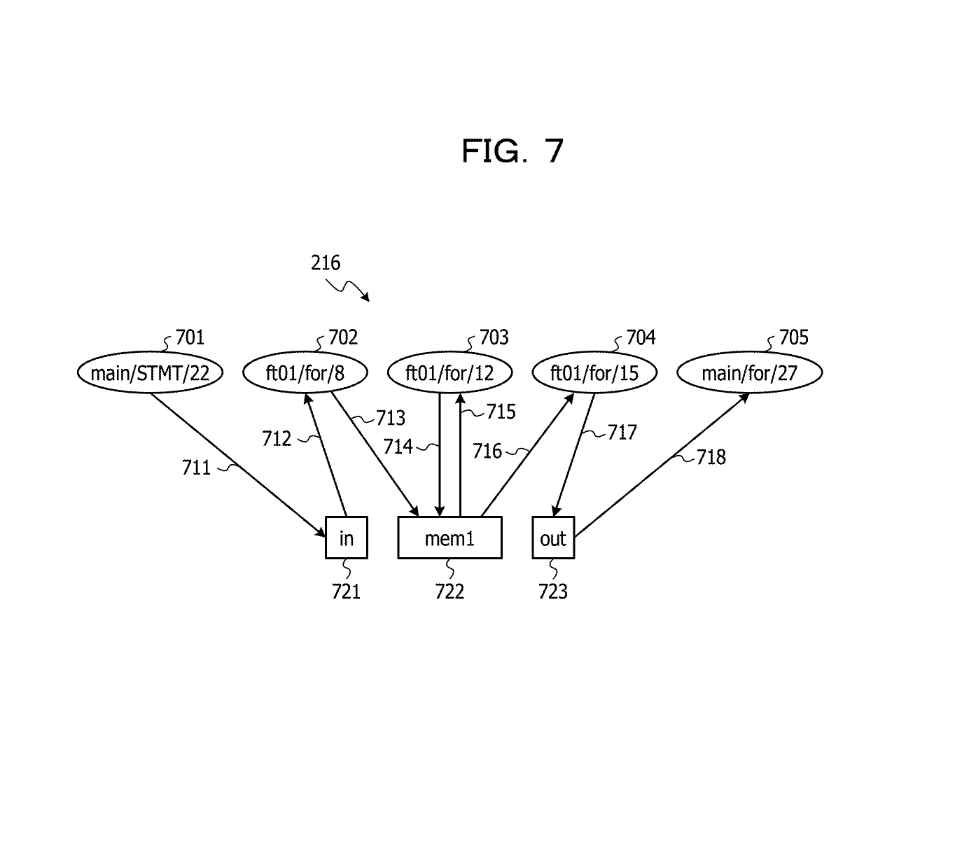

FIG. 7 is a diagram illustrating an example of a graph structure 216 generated by the grouping module 205 and the labeling module 206 in FIG. 2. Running the grouping module 205, the CPU 102 generates the graph structure 216 by grouping the instruction address nodes and the memory address nodes. The graph structure 216 contains instruction address nodes 701 to 705, edges 711 to 718, and memory address nodes 721 to 723. In this case, the analysis range specifying file 214 contains, as analysis ranges, information on the variables in, mem1, and out in FIG. 3.

Running the grouping module 205, the CPU 102 groups instruction address nodes for each code block in the source file 211 based on the debug information in the executable file 212 to generate the instruction address nodes 701 to 705. The instruction address node 701 is formed by grouping together the instruction address nodes for the code block on the lines 22 to 25 in the function main in FIG. 3. The instruction address node 702 is formed by grouping the instruction address nodes for the first code block 301 on the lines 8 to 11 in the function ft01 in FIG. 3. The instruction address node 703 is formed by grouping the instruction address nodes for the second code block 302 on the lines 12 to 14 in the function ft01 in FIG. 3. The instruction address node 704 is formed by grouping the instruction address nodes for the third code block 303 on the lines 15 to 17 in the function ft01 in FIG. 3. The instruction address node 705 is formed by grouping the instruction address nodes for the code block on the line 27 in the function main in FIG. 3.

In addition, running the grouping module 205, the CPU 102 groups memory address nodes for each variable name in the source file 211 based on the debug information in the executable file 212 to generate the memory address nodes 721 to 723. The memory address node 721 is formed by grouping the memory address nodes for the variable name in FIG. 3. The memory address node 722 is formed by grouping the memory address nodes for the variable name mem1 in FIG. 3. The memory address node 723 is formed by grouping the memory address nodes for the variable name out in FIG. 3.

The edge 711 is an edge directed from the instruction address node 701 to the memory address node 721 and represents the write instruction W. The edge 712 is an edge directed from the memory address node 721 to the instruction address node 702 and represents the read instruction R. The edge 713 is an edge directed from the instruction address node 702 to the memory address node 722 and represents the write instruction W. The edge 714 is an edge directed from the instruction address node 703 to the memory address node 722 and represents the write instruction W. The edge 715 is an edge directed from the memory address node 722 to the instruction address node 703 and represents the read instruction R. The edge 716 is an edge directed from the memory address node 722 to the instruction address node 704 and represents the read instruction R. The edge 717 is an edge directed from the instruction address node 704 to the memory address node 723 and represents the write instruction W. The edge 718 is an edge directed from the memory address node 723 to the instruction address node 705 and represents the read instruction R.

Moreover, running the labeling module 206, the CPU 102 refers to the source file 211 in FIG. 3 and thereby assigns labels related to the source file 211 to the instruction address nodes 701 to 705 and the memory address nodes 721 to 723 in the graph structure 216 grouped by the grouping module 205. The instruction address nodes 701 to 705 and the memory address nodes 721 to 723 are assigned with the labels related to the source file 211, and therefore are easily understandable by the designer.

Specifically, the CPU 102 assigns a label of “symbol (function name)/code block name/line number” in the source file 211 to each of the instruction address nodes 701 to 705. The instruction address node 701 is assigned with the label of “main/STMT/22”, which indicates that the function name is main, the code block name is statement (STMT), and the start line number is 22. The instruction address node 702 is assigned with the label of “ft01/for/8”, which indicates that the function name is ft01, the code block name is for sentence, and the start line number is 8. The instruction address node 703 is assigned with the label of “ft01/for/12”, which indicates that the function name is ft01, the code block name is for sentence, and the start line number is 12. The instruction address node 704 is assigned with the label of “ft01/for/15”, which indicates that the function name is ft01, the code block name is for sentence, and the start line number is 15. The instruction address node 705 is assigned with the label of “main/for/27”, which indicates that the function name is main, the code block name is for sentence, and the start line number is 27.

Then, the labeling module 206 assigns a label of “variable name” in the source file 211 to each of the memory address nodes 721 to 723. The memory address node 721 is assigned with the label of “in”, which indicates that the variable name is in. The memory address node 722 is assigned with the label of “mem1”, which indicates that the variable name is main. The memory address node 723 is assigned with the label of “out”, which indicates that the variable name is out.

Next, running the output module 207 in FIG. 2, the CPU 102 outputs the graph structure 216 in which the labels are assigned by the labeling module 206 to the output device 107 in FIG. 1. The output device 107 is a display or a printer, and displays or prints out the graph structure 216.

With reference to the graph structure 216, the designer may relatively easily rewrite the hardware behavioral description aiming at the hardware architecture. For example, with reference to the graph structure 216, the designer may find processes executable in parallel, and create hardware behavioral description to cause parallel processing of the processes thus found. The accelerator may achieve speed-up of processing by performing parallel processing. The parallel processing includes data-level parallel processing and task-level parallel processing. The data-level parallel processing corresponds to single instruction, multiple data (SIMD) processing. The task-level parallel processing corresponds to parallel processing of multiple pipelines.

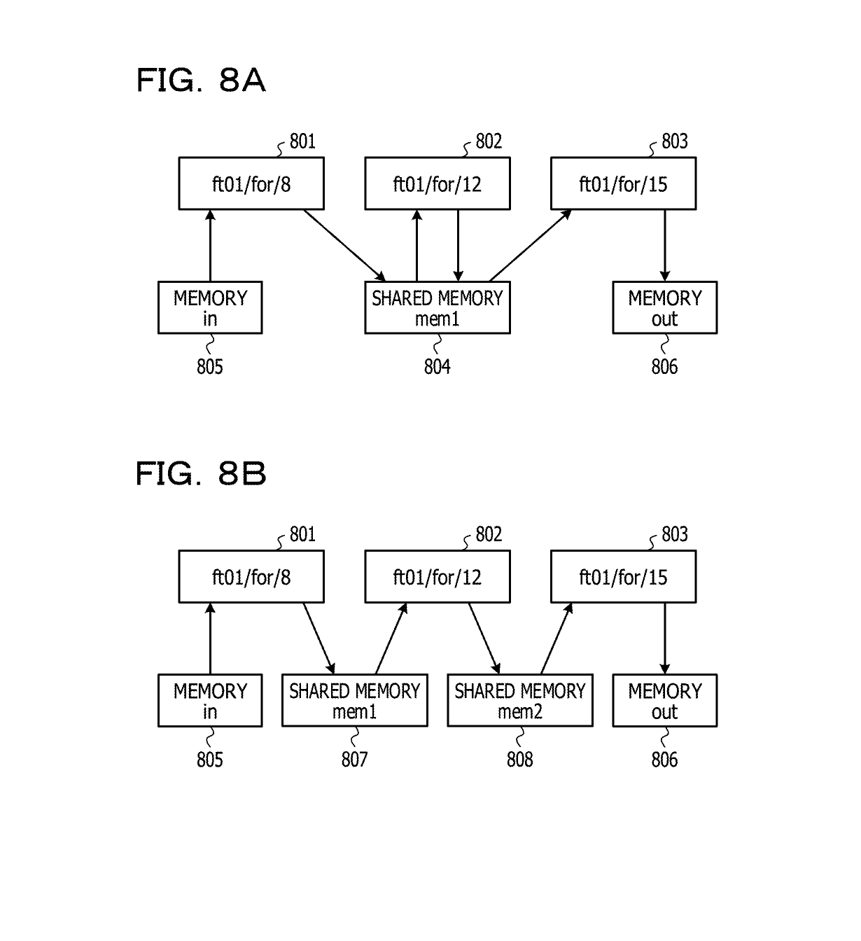

FIG. 8A is a diagram illustrating a configuration example of an accelerator 800 including a shared memory 804, and may be created by the designer using some elements in FIG. 7. The accelerator 800 includes circuits 801 to 803, a shared memory 804, and memories 805 and 806. The circuit 801 is a circuit that executes the processing of the instruction address node 702 in FIG. 7, for example. The circuit 802 is a circuit that executes the processing of the instruction address node 703 in FIG. 7, for example. The circuit 803 is a circuit that executes the processing of the instruction address node 704 in FIG. 7, for example. The shared memory 804 stores data for the variable mem1 correspondent with the memory address node 722 in FIG. 7, for example. The memory 805 stores data for the variable in correspondent with the memory address node 721 in FIG. 7, for example. The memory 806 stores data for the variable out correspondent with the memory address node 723 in FIG. 7, for example. Since all of the circuits 801 to 803 are capable of accessing the shared memory 804, access collision may occur. For example, in a period when the circuit 801 is accessing the shared memory 804, the circuits 802 and 803 are not allowed to access the shared memory 804. Moreover, it is mandatory to correctly control the execution order of the circuits 801, 802, and 803 for the purpose of performing correct calculations. For these reasons, it is difficult to cause the circuits 801 to 803 to perform parallel processing, and accordingly difficult to achieve the high-speed processing. In other words, the current source file 211 is made without taking the hardware architecture into account, and does not allow the designer to easily create an accelerator capable of parallel processing. By viewing FIG. 7, the designer may notice that many memory accesses are concentrated at the variable mem1, and seek for a solution to improve the source code concerning the variable mem1.

FIG. 8B is a diagram illustrating a configuration example of an accelerator 810 aiming at the hardware architecture. This may be obtained by making the following corrections in the source code in FIG. 3.

Line 6int mem1[8], mem2[8];

Line 13mem2[j]=mem1[j]*5/t0;

Line 16out[j]=mem2[j]+1;

When the corrected source code is applied as the source file 211 in FIG. 2, a similar graph in FIG. 8B may be outputted. The accelerator 810 includes circuits 801 to 803, memories 805 and 806, and shared memories 807 and 808. The memory 805 stores data for the variable in. The memory 806 stores data for the variable out. The shared memory 807 stores data for the variable mem1. The shared memory 808 stores data for the variable mem2. Although the memory 807 is shared by the circuit 801 and the circuit 802, their accesses are for write only and read only, respectively. In this case, the circuit 801 and the circuit 802 may be made executable concurrently by using a dual-port memory as the memory 807 and appropriately controlling their processing start timings. The same holds for the memory 808. Thus, in FIG. 8B, a proportion where parallel processing is feasible is larger than in FIG. 8A, and accordingly an accelerator with higher performance may be implemented.

The high-level synthesis tool may transform the hardware behavioral description in the high-level language to a hardware description language (HDL) file in order to develop an accelerator. However, when pointer variables are used in the behavioral description in the high-level language, the high-level synthesis tool may fail to synthesize circuits capable of efficient processing. When a value of a pointer variable is used as an argument to call a function, the variable name may change in some cases. For this reason, by just looking at the source code, it is difficult to immediately judge whether or not pointer variables point to the same memory area. Meanwhile, by referring to the graph structure 216, the designer may easily know that variables even having different variable names actually point to the same memory area. This is useful at an early stage of planning circuit architecture.

In the work of task division and memory division conducted at the stage of planning circuit architecture, the hardware designer may obtain information as hints for the work from the graph structure 216, and thereby achieve a reduction in man-hours.

FIG. 9 is a flowchart presenting a processing example of the dynamic analysis tool 202 in FIG. 2. The CPU 102 performs processing in steps S901 to S903 by running the dynamic analysis tool 202.

In step S901, the dynamic analysis tool 202 loads the executable file (program under analysis) 212, the input data file 213, and the analysis range specifying file 214 from the external storage device 108.

Here, the dynamic analysis tool 202 has a function like a software debugger GDB. Next, in step S902, by referring to the debug information in the executable file 212 and the source file 211, the dynamic analysis tool 202 sets a first breakpoint at a location immediately after a memory is allocated to a variable (analysis range) specified by the analysis range specifying file 214. For example, in the case where the analysis range is the variable mem1, the dynamic analysis tool 202 sets the first breakpoint at the location in the program of the executable file 212 immediately after a memory is allocated to the variable mem1 on the line 6 in the source file 211 in FIG. 3. For example, memory areas are allocated to the variables in and out at the start of execution of the function main, whereas a memory area is allocated to the variable mem1 at the start of execution of the function ft01.

In addition, by referring to the debug information in the executable file 212 and the source file 211, the dynamic analysis tool 202 sets a second breakpoint at a location immediately before the memory allocated to a variable (analysis range) specified by the analysis range specifying file 214 is released. For example, in the case where the analysis range is the variable mem1, the dynamic analysis tool 202 sets the second breakpoint at the location in the program of the executable file 212 immediately before the memory allocated to the variable mem1 is released at the end of the function ft01 on the line 18 in the source file 211 in FIG. 3. Since each of the variables in, out, mem1, and so on is a variable declared in the function, the memory area is released at the end of the function.

Next, in step S903, the dynamic analysis tool 202 starts execution of the executable file (program under analysis) 212.

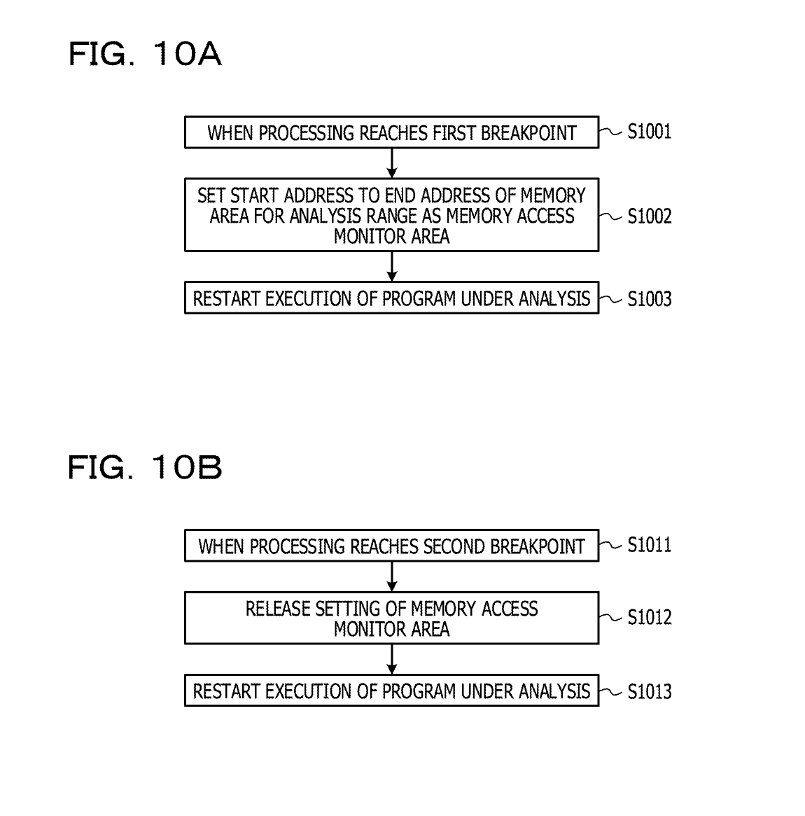

FIG. 10A is a flowchart presenting a processing example in the case where the processing reaches the first breakpoint set in step S902 in FIG. 9. Running the dynamic analysis tool 202, the CPU 102 performs processing in steps S1001 to S1003.

If the dynamic analysis tool 202 detects the processing of the executable file (program under analysis) 212 reaching the first breakpoint in step S1001, the dynamic analysis tool 202 advances to step S1002. In step S1002, the dynamic analysis tool 202 sets, as a memory access monitor area, the start address to the end address of the memory area allocated to the variable at the analysis range. Next, in step S1003, the dynamic analysis tool 202 restarts the execution of the executable file (program under analysis) 212.

FIG. 1013 is a flowchart presenting a processing example in the case where the processing reaches the second breakpoint set in step S902 in FIG. 9. Running the dynamic analysis tool 202, the CPU 102 performs processing in steps S1011 to S1013.

If the dynamic analysis tool 202 detects the processing of the executable file (program under analysis) 212 reaching the second breakpoint in step S1011, the dynamic analysis tool 202 advances to step S1012. In step S1012, the dynamic analysis tool 202 releases the setting of the memory access monitor area related to the second breakpoint. Next, in step S1013, the dynamic analysis tool 202 restarts the execution of the executable file (program under analysis) 212.

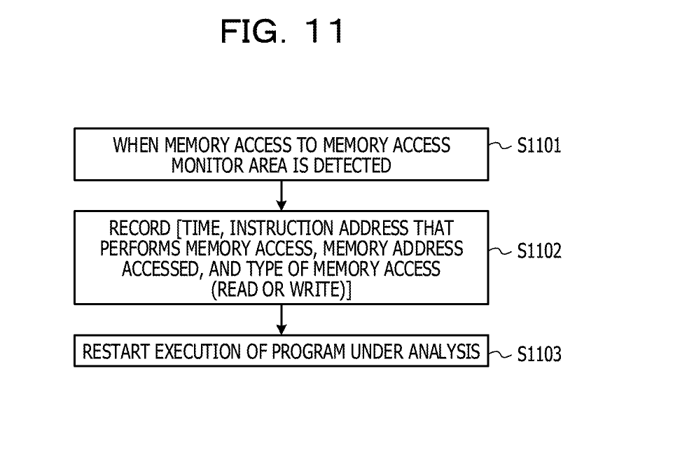

FIG. 11 is a flowchart presenting a processing example in the case where the memory access monitor area set in step S1002 in FIG. 10A is accessed. Running the dynamic analysis tool 202, the CPU 102 performs processing in steps S1101 to S1103.

If the dynamic analysis tool 202 detects that a memory access to the memory access monitor area is carried out by the processing of the executable file (program under analysis) 212 in step S1101, the dynamic analysis tool 202 advances to step S1102. In step S1102, the dynamic analysis tool 202 records the memory access data 215 into the external storage device 108 according to the detected memory access, the memory access data 215 containing the time 401, the instruction address 402 that performs the memory access, the accessed memory address 403, and the type 404 of the memory access (read or write). Next, in step S1103, the dynamic analysis tool 202 restarts the execution of the executable file (program under analysis) 212.

The aforementioned memory access monitor performed by the dynamic analysis tool 202 may be carried out by any of several methods. One of the methods is to use the CPU 102 having a function called watch point which generates an interrupt when a memory access to a designated address is performed. When an interrupt is generated by the watch point, the memory access data 215 can be recorded by interrupt handling program. Another method is to use a function held by the CPU 102 to execute instructions one by one by step execution. In this case, when a memory access instruction is found, whether the memory access instruction accesses to the memory access monitor area or not is checked, and the memory access data 215 is recorded if the memory access monitor area is accessed.

The memory access monitor by the dynamic analysis tool 202 may be carried out by software. The program is executed on a CPU emulator, a memory access to the monitor area by the program is detected by the CPU emulator, and the memory access data 215 is recorded. For example, the dynamic analysis tool 202 may be implemented by using a tool VALGRIND, popular software to detect memory-related bugs, configured to detect memory access and a software debugger GDB in combination.

FIG. 12 is a flowchart presenting a processing example of the memory access data analysis tool 203 in FIG. 2. Running the memory access data analysis tool 203, the CPU 102 inputs the memory access data 215 in FIG. 4 and the designated number of nodes N in FIG. 2 given by the designer.

In step S1201, the memory access data analysis tool 203 transforms the memory access data 215 in FIG. 4 into the graph structure 500 in FIG. 5A by running the graph generation module 204.

The processing in steps S1202 to S1207 is executed by the memory access data analysis tool 203 running the grouping module 205. First, in step S1202, the memory access data analysis tool 203 enumerates grouping processes F0, F1, . . . based on the aforementioned first to tenth grouping processes. Even when there are ten types of grouping processes, for example, a huge number of Fs are enumerated because there are a plurality of targets to which the grouping processes are to be applied.

Next, in step S1203, the memory access data analysis tool 203 obtains node decrease numbers D0, D1, . . . for the respective grouping processes F0, F1, . . . , where the node decrease number represents the number of nodes by which the nodes are decreased from the graph structure 500 before the grouping to the graph structure after the grouping.

Next, in step S1204, the memory access data analysis tool 203 sorts the grouping processes F0, F1, . . . in ascending order of the node decrease number D0, D1, . . . to generate a list FL. The order for sorting is not limited to the above order. There is an evaluation function E that gives an evaluation value to each of the grouping processes F0, F1, . . . , and the memory access data analysis tool 203 calculates E(F0)=D0, E(F1)=D1, . . . as the evaluation values. Then, the memory access data analysis tool 203 sorts the grouping processes F0, F1, . . . in ascending order of the evaluation value D0, D1, . . . to generate a list FL.

Next, in step S1205, the memory access data analysis tool 203 judges whether or not the total node number of the instruction address nodes and memory address nodes in the current graph structure is equal to or less than the designated number of nodes N. The memory access data analysis tool 203 advances to step S1208 if the total node number is equal to or less than the designated number of nodes N, or advances to step S1206 if the total node number is more than the designated number of nodes N.

In step S1206, the memory access data analysis tool 203 judges whether the list FL is empty or not. The memory access data analysis tool 203 advances to step S1207 if the list FL is not empty, or displays an error and terminates the processing in FIG. 12 if the list FL is empty.

In step S1207, the memory access data analysis tool 203 takes out the grouping process from the top of the list FL, deletes the taken-out grouping process from the list FL, and performs the taken-out grouping process on the current graph structure to generate the graph structure thus grouped.

Thereafter, the memory access data analysis tool 203 returns to step S1205, and iterates the above processing until the total node number in the current graph structure becomes equal to or less than the designated number of nodes N. Until the total number of instruction address nodes and memory address nodes in the current graph structure becomes equal to or less than the designated number of nodes N, the memory access data analysis tool 203 performs multiple types of grouping processes in ascending order of the number of nodes by which the total number of instruction address nodes and memory address nodes is decreased by the grouping process.

In step S1208, running the labeling module 206, the memory access data analysis tool 203 generates the graph structure 216 by referring to the source file 211 and labeling related to the source file 211 to the instruction address nodes and the memory address nodes in the graph structure grouped by the grouping module 205.

Next, in step S1209, running the output module 207, the memory access data analysis tool 203 outputs the graph structure 216 in which the labels are assigned by the labeling module 206 to the output device 107. The output device 107 displays or prints out the graph structure 216 that is easily understandable by human.

As described above, the information processing apparatus 100 is capable of presenting the graph structure 216 to the designer and thereby assisting the designer to create the hardware behavioral description aiming at the hardware architecture.

All the foregoing embodiments are described as just specific examples for carrying out the present disclosure, and the technical scope of the present disclosure is not to be interpreted in a manner limited by these embodiments. In other words, the present disclosure may be carried out in various ways without departing from the technical idea of the present disclosure or the main features thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory, the processor is configured to:
acquire, by analyzing a program, a first address of the memory at which a memory access instruction in the program is stored, and a second address of the memory to be accessed by the memory access instruction; and
generate first information indicating a correspondence between the first address and the second address.

2. The information processing apparatus according to claim 1, wherein
the program includes debug information indicating a correspondence between the program and a source code of the program before compiling,
the processor acquires the first address and the second address for an access of a specified variable name in the source code based on the debug information.

3. The information processing apparatus according to claim 1, wherein
the processor is configured to generate, based on the first information, a graph structure including a plurality of first nodes representing the first addresses, a plurality of second nodes representing the second addresses, and a plurality of edges representing correspondences between the plurality of first nodes and the plurality of second nodes.

4. The information processing apparatus according to claim 3, wherein
the processor is configured to
acquire second information indicating whether the memory access instruction is a read instruction or a write instruction to the memory;, and
generate an edge having a direction according to the second information.

5. The information processing apparatus according to claim 3, wherein
the processor is configured to decrease a number of the first nodes, a number of the second nodes, or both the number of the first nodes and the number of the second nodes in the graph structure by performing a first grouping of the plurality of first nodes, a second grouping of the plurality of second nodes, or a third grouping including both of the first grouping and the second grouping.

6. The information processing apparatus according to claim 5, wherein
the processor is configured to perform one of the first grouping, the second grouping and the third grouping such that a total number of the first nodes and the second nodes becomes equal to or less than a designated number of nodes.

7. The information processing apparatus according to claim 5, wherein
the processor is configured to perform, until a total number of the first nodes and the second nodes becomes equal to or less than a designated number of nodes, a plurality of groupings including the first grouping, the second grouping and the third grouping in ascending order of a number of nodes which is decreased by the respective groupings.

8. The information processing apparatus according to claim 5, wherein
the processor is configured to:
acquire time information on a time at which the memory access instruction is to be executed; and
form a group of the second nodes correspondent with memory accesses in which the time information is consecutive.

9. The information processing apparatus according to claim 5, wherein
the program includes debug information indicating a correspondence between the program and a source code of the program before compiling, and
the processor performs the second grouping for variable name in the source code based on the debug information.

10. The information processing apparatus according to claim 5, wherein
the program includes debug information indicating a correspondence between the program and a source code of the program before compiling, and
the processor performs the first grouping for code block in the source code based on the debug information.

11. The information processing apparatus according to claim 5, wherein
the processor is configured to assign, based on a source code of the program before compiling, a label corresponding to the source code to the first nodes and the second nodes in the graph structure.

12. The information processing apparatus according to claim 11, wherein
the processor is configured to:
assign a label containing a function name or a line number in the source code to each of the first nodes; and
allocate a label containing a variable name in the source code to each of the second nodes.

13. The information processing apparatus according to claim 11, wherein
the processor is configured to output the graph structure in which the label is assigned.

14. An information processing method comprising:
acquiring, by a computer, by analyzing a program, a first address of a memory at which a memory access instruction in the program is stored, and a second address of the memory to be accessed by the memory access instruction; and
generating first information indicating a correspondence between the first address and the second address.

15. The information processing method according to claim 14, wherein
the program includes debug information indicating a correspondence between the program and a source code of the program before compiling,
the first address and the second address for an access of a specified variable name in the source code are acquired based on the debug information.

16. The information processing method according to claim 14, further comprising:
generating, based on the first information, a graph structure including a plurality of first nodes representing the first addresses, a plurality of second nodes representing the second addresses, and a plurality of edges representing correspondences between the plurality of first nodes and the plurality of second nodes.

17. A non-transitory computer-readable recording medium recording a program which causes a computer to perform operations, the operations comprising:
acquiring, by analyzing a program, a first address of a memory at which a memory access instruction in the program is stored, and a second address of the memory to be accessed by the memory access instruction; and
generating first information indicating a correspondence between the first address and the second address.

18. The non-transitory computer-readable recording medium according to claim 17, wherein
the program includes debug information indicating a correspondence between the program and a source code of the program before compiling,
the first address and the second address for an access of a specified variable name in the source code are acquired based on the debug information.

19. The non-transitory computer-readable recording medium according to claim 17, further comprising:
generating, based on the first information, a graph structure including a plurality of first nodes representing the first addresses, a plurality of second nodes representing the second addresses, and a plurality of edges representing correspondences between the plurality of first nodes and the plurality of second nodes.
